(19) United States
(12) Patent Application Publication
(10) Pub. No.: US 2026/0281551 A1
(43) Pub. Date: Sep. 17, 2026

(54) ELECTRONIC IMAGE STABILIZATION WITH IMAGE EXTRAPOLATION

(71) Applicant: MEDIATEK INC., Hsinchu City (TW)

(72) Inventors: Meng-Hung Cho, Hsinchu City (TW); Shu-Fan Wang, Hsinchu City (TW); Te-Hao Chang, Hsinchu City (TW); Ying-Jui Chen, Hsinchu City (TW); Sheng-Po Kuo, Hsinchu City (TW); Cheng-Wei Wu, Hsinchu City (TW); Chia-Ping Chen, Hsinchu City (TW); Yan-Shao Liu, Hsinchu City (TW); Chi-Cheng Ju, Hsinchu City (TW)

(73) Assignee: MEDIATEK INC., Hsinchu City (TW)

(21) Appl. No.: 19/075,811

(22) Filed: Mar. 11, 2025

(51) Int. Cl. H04N 23/68; H04N 23/69

(52) U.S. Cl. CPC H04N 23/683; H04N 23/6811; H04N 23/6812; H04N 23/69

(57) ABSTRACT

A method for electronic image stabilization (EIS) includes obtaining a frame image with first field of view (FOV) from an image sensor, obtaining motion data associated with the frame image, extrapolating pixels around borders of the frame image to obtain an extended field of view of the frame image, analyzing the motion data to determine a stabilization correction based on an extended electronic image stabilization (EIS) margin, and applying the stabilization correction to the frame image with the extended field of view to generate a stabilized frame image. The extended EIS margin is derived from the extended field of view.

### BACKGROUND

Electronic Image Stabilization (EIS) has become a cornerstone feature in modern digital imaging devices, including smartphones, action cameras, and professional video equipment. This technology aims to mitigate the effects of camera shake and unintended motion, allowing users to capture smooth, professional-looking video footage even in challenging conditions such as walking, running, or filming from moving vehicles.

Traditional EIS systems operate on a fundamental principle: they capture a larger field of view (FOV) than the final output video and use this extra margin to digitally reposition each frame, counteracting detected motion. This process effectively creates a floating window within the larger captured frame, which moves opposite to the camera's motion to maintain a stable image. While this approach has proven effective for mild to moderate camera movements, it faces significant limitations when confronted with more extreme scenarios.

The primary challenge in conventional EIS implementations lies in the inherent trade-off between stabilization quality and preserved field of view. As the magnitude of motion increases, the system requires a larger margin around the frame to effectively compensate for movement. This larger margin necessitates a more substantial crop of the original image, resulting in a narrower FOV in the final stabilized video. In high-motion scenarios, such as action sports or handheld footage in turbulent environments, the EIS system may exhaust its available margin, leading to either insufficient stabilization or an unacceptably narrow field of view.

Despite these advancements, current commercial EIS solutions have not fully leveraged these technologies to address the fundamental limitations of traditional stabilization methods. There remains a significant opportunity to integrate cutting-edge techniques into a next-generation EIS system that can maintain high-quality stabilization while preserving or even expanding the field of view, particularly in challenging high-motion scenarios. While EIS has come a long way since its inception, current implementations still face significant limitations, particularly in high-motion scenarios. The convergence of advanced computational techniques with the evolving hardware capabilities of modern imaging devices presents a unique opportunity to overcome these limitations and usher in a new era of video stabilization technology.

### SUMMARY

An embodiment discloses a method for electronic image stabilization. The method comprises obtaining a frame image with first field of view (FOV) from an image sensor, obtaining motion data associated with the frame image, extrapolating pixels around borders of the frame image to obtain an extended field of view of the frame image, analyzing the motion data to determine a stabilization correction based on an extended electronic image stabilization (EIS) margin, and applying the stabilization correction to the frame image with the extended field of view to generate a stabilized frame image. The extended EIS margin is derived from the extended field of view.

An embodiment discloses an apparatus comprising an image sensor and a processor coupled to the image sensor. The image sensor is used to obtaining a frame image with first field of view (FOV). The processor is used to obtain motion data associated with the frame image, extrapolate pixels around borders of the frame image to obtain an extended field of view of the frame image, analyze the motion data to determine a stabilization correction based on an extended electronic image stabilization (EIS) margin, and apply the stabilization correction to the frame image with the extended field of view to generate a stabilized frame image. The extended EIS margin is derived from the extended field of view.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a simplified block diagram of an imaging device according to the embodiments.

FIG. 2 depicts process of using generative artificial intelligence (GenAI) to extend the field of view of an image for improved EIS according to the embodiments.

FIG. 3 depicts a technique for extending the field of view in a shaking video sequence using information from previous frames according to the embodiments.

FIG. 4A to 4B depict a technique of multi-sensor or multi-camera spatial fusion optimized for EIS according to the embodiments.

FIG. 5 depicts a flowchart of a method for the electronic image stabilization according to the embodiments.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

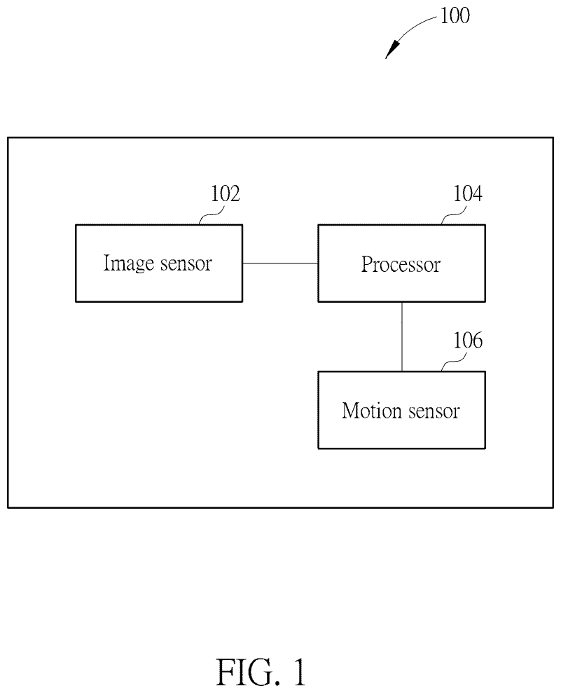

FIG. 1 depicts a simplified block diagram of an imaging device 100 according to the embodiments. The imaging device 100 comprises an image sensor 102, a processor 104 coupled to the image sensor 102, and a motion sensor 106 coupled to the processor 104. The imaging device 100 employs various ways to detect motion and capture image data. Motion detection is achieved through the use of motion sensor 106, which can be implemented using various technologies such as gyroscopes, accelerometers, optical image stabilization (OIS) sensors, MEMS (Micro-Electro-Mechanical Systems) sensors, optical flow sensors, inertial measurement units (IMUs), and angular displacement sensors. For image capture, the imaging device 100 uses image sensors 102, which may include CMOS (Complementary Metal-Oxide-Semiconductor) sensors, CCD (Charge-Coupled Device) sensors, and/or ToF (Time-of-Flight) sensors, among others.

The above described image sensors come in a wide range of sizes, from compact sensors used in smartphones to larger formats employed in professional cameras. They also vary significantly in terms of resolution, sensitivity, and specialized features. The selection of a particular sensor can determine the camera's overall performance, particularly in challenging conditions such as low-light environments, and affects key parameters like dynamic range and operational speed. Similarly, the choice of motion sensors depends on various factors including the intended use case, device form factor, power constraints, and required precision. For instance, a professional video camera might employ a high-precision IMU along with angular displacement sensors for maximum stability, while a smartphone might rely on a compact MEMS-based solution that balances performance with power efficiency. Moreover, the integration and fusion of data from multiple sensor types can provide more robust and accurate motion detection. Advanced systems often combine data from gyroscopes, accelerometers, and optical flow analysis to create a comprehensive understanding of camera movement, enabling more effective stabilization across a wide range of scenarios.

In addition, the processor 104 may be implemented with a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof.

The imaging device 100 serves as a representative example of hardware capable of implementing the electronic image stabilization (EIS) techniques described in subsequent sections. This device embodies the necessary components and architecture to execute the advanced stabilization methods that will be detailed, providing a practical framework for understanding how these techniques can be applied in real-world imaging systems.

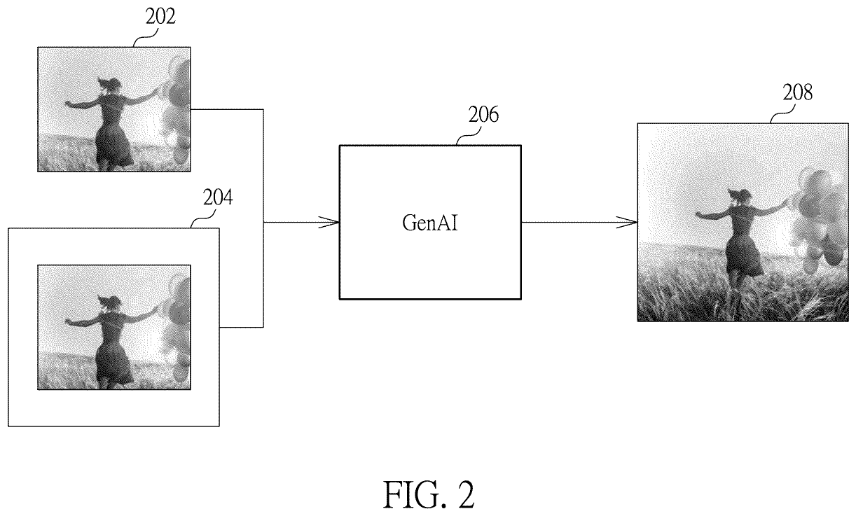

FIG. 2 depicts process of using generative artificial intelligence (GenAI) to extend the field of view of an image for improved EIS according to the embodiments. The image 202 captured by an image sensor (e.g., image sensor 102) shows the photograph of a woman in a field holding balloons. An image 204 represents the same photo but with a border around it, indicating the area where new content needs to be generated to extend the field of view (FOV).

The images 202 and 204 are input into a GenAI model 206, which then produces an image 208 with the extended FOV. The GenAI has synthesized additional pixels around the borders, extending the FOV. This is particularly noticeable in the lower right corner, where more of the field and balloons have been generated.

The extent of the generated region is crucial to enhancing stabilization effectiveness. However, it is important to balance this with power consumption considerations. The system allows for dynamic adjustment of the generated area based on specific conditions and requirements.

Determining the optimal generated region involves several factors. Firstly, a processor (e.g., processor 104) can be configured to extend the image uniformly around all borders or focus on specific regions as needed. This flexibility allows for efficient use of computational resources while maximizing stabilization effectiveness.

Secondly, the magnitude of camera shake serves as a key parameter in determining the proportion of extension. As the intensity of motion increases, the processor, with the assistance of data from motion sensor (e.g., motion sensor 106), can correspondingly expand the generated region to provide adequate compensation. This adaptive approach ensures robust stabilization even in high-motion scenarios.

Lastly, the direction of imaging device movement is taken into account when deciding which regions to prioritize for extension. For instance, if the motion sensor detects predominant motion towards the right, the processor would allocate more resources to extending the right side of the frame.

By considering these factors, the imaging device can optimize the trade-off between stabilization quality and computational efficiency, providing superior electronic image stabilization across a wide range of usage scenarios.

The generative AI (GenAI) technique for extending the FOV in electronic image stabilization offers several significant advantages. Firstly, it provides unprecedented flexibility in image extension. Unlike traditional methods that are limited by the physical constraints of the camera sensor, GenAI can synthesize entirely new content beyond the original frame boundaries. This capability allows for potentially unlimited extension of the field of view, providing ample margin for stabilization even in extreme motion scenarios. In addition, the GenAI approach offers superior contextual awareness. By learning from vast datasets of images, the AI model can generate extensions that are contextually appropriate and visually coherent with the original frame. For instance, in the example image, the model seamlessly extends the wheat field and sky, maintaining the overall aesthetic and realism of the scene.

Furthermore, this technique adapts dynamically to different scenes and motion patterns. The GenAI model can adjust its output based on the specific content of each frame, the direction and intensity of motion, and even the overall style of the video. This adaptability ensures optimal stabilization across a wide range of shooting conditions and environments. Another significant advantage is the potential for computational efficiency. While initial implementation may be resource-intensive, advancements in AI hardware and optimized algorithms can potentially make this technique more efficient than traditional pixel-based methods, especially for complex scenes.

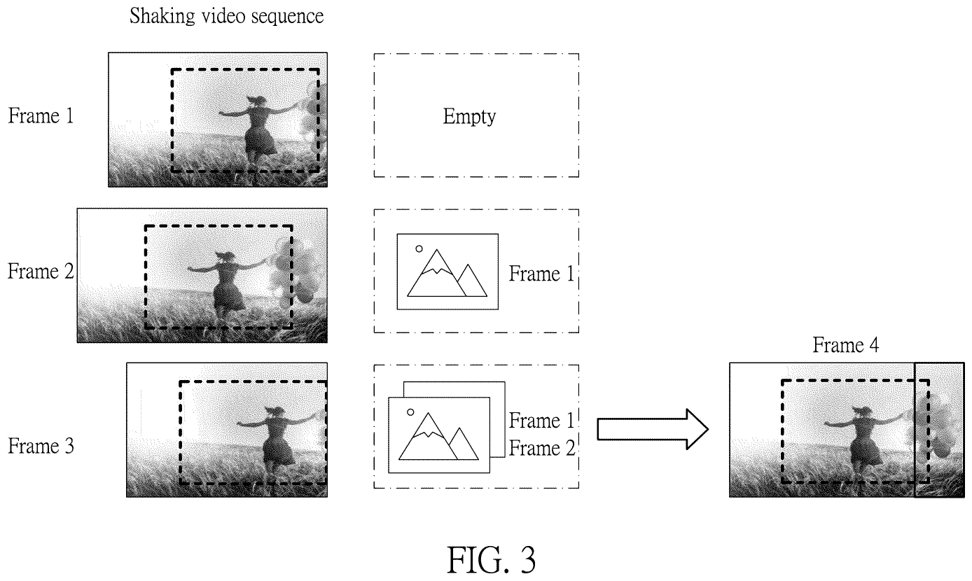

FIG. 3 depicts a technique for extending the field of view in a shaking video sequence using information from previous frames according to the embodiments. The figure shows three consecutive frames (frame 1, frame 2, and frame 3). Each frame is accompanied by a box on the right, representing a queue for historical frames. For frame 1, this queue is empty. For frame 2, the queue contains frame 1. For frame 3, the queue contains both frame 1 and frame 2.

The key concept illustrated here is that frame 1 and frame 2 includes more information about the right side of the scene due to the camera shake. This additional information can be used to extend the visible region of frame 3.

By incorporating frame 1 and frame 2, the visible region of frame 3 can be extended to produce frame 4. The frame 4 shows more of the balloons on the right side, which was not visible in frame 3 but was captured in the previous frames (i.e., frames 1 and 2).

This technique allows the original frame 3 to have an expanded FOV (i.e., frame 4) by incorporating the content from frame 1 and frame 2, effectively increasing the visible range of the image. This approach is particularly useful for EIS, as it provides more margins for stabilization without losing image content.

This technique offers significant advantages for EIS and video quality enhancement. By utilizing information from frame 1 and frame 2 to extend frame 3 into frame 4 (the extended frame 3), the technique effectively increases the visible area of the scene, which is particularly beneficial for maintaining context and composition in stabilized video. The frame 4 provides a larger buffer area for EIS algorithms to work with, allowing for more aggressive stabilization without sacrificing edge content, resulting in smoother video output. Unlike traditional EIS methods that may crop the frame, this technique preserves and even expands the visible content. For example, the balloons on the right side, which might have been lost in conventional stabilization, are retained in frame 4.

Moreover, by incorporating information from frame 1 and frame 2 into frame 4, the technique ensures a more temporally consistent video output, reducing jarring transitions or sudden appearance/disappearance of objects at the frame edges. The method naturally adapts to the direction of camera shake, compensating for motion in any direction as needed. It also makes efficient use of already captured image data from previous frames, rather than relying solely on computationally intensive generative methods. Additionally, by reducing the overall movement between frames in the stabilized video, this approach could potentially lead to better video compression, as there may be less change for codecs to encode between successive frames. In essence, this sophisticated evolution in EIS technology leverages temporal information to overcome the physical limitations of the camera sensor, providing a more immersive and stable viewing experience.

In certain implementations, the historical frame technique (illustrated by FIG. 3) employs a sophisticated adaptive approach to manage frame storage for image stabilization. The processor (i.e., processor 104) can allow for flexible queue sizes, which can be either fixed or dynamically adjusted based on current conditions. The key innovation lies in its responsiveness to motion intensity. During periods of significant camera shake, when the visible areas between frames can vary greatly, the system may opt to retain a larger number of historical frames. This expanded data pool provides more comprehensive information for extending the FOV of the frame image. Conversely, in scenarios with minimal movement, where consecutive frames show little variation, the system can efficiently reduce the number of stored historical frames, optimizing resource usage without compromising stabilization quality.

Furthermore, the technique offers versatility in frame storage methods. Historical frames can be preserved in their entirety or as partial images, allowing for fine-tuned memory management. This adaptive storage strategy is closely tied to motion detection. In high-motion situations, the system tends to store more complete historical frames, ensuring a rich dataset for complex stabilization tasks. During periods of low motion, it may store only partial frames or fewer frames overall, striking a balance between effective stabilization and resource conservation.

This dynamic queue management approach brings several advantages to EIS. It enables efficient resource utilization by adjusting memory usage in real-time, enhances stabilization quality in challenging high-motion scenarios by providing comprehensive historical data, and reduces computational overhead in low-motion environments by optimizing data storage and processing. The result is a highly responsive and efficient stabilization system that adapts to varying degrees of camera motion, from high-shake scenarios to stable shooting conditions, delivering optimal performance across a wide range of situations.

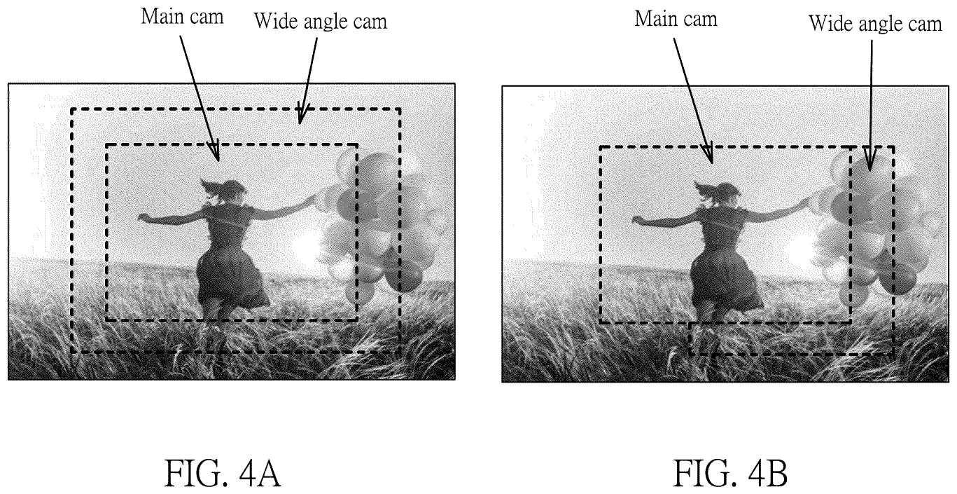

FIGS. 4A and 4B depict a technique of multi-sensor or multi-camera spatial fusion optimized for EIS according to the embodiments. FIG. 4A depicts a conventional approach, showcasing two overlapping fields of view (FOV). Specifically, a larger frame represents the complete (or called full) FOV of an ultra-wide camera, and a smaller frame indicates the FOV of the main camera. FIG. 4B depicts an optimized configuration for the EIS. The inner frame representations of the FOV of the main image sensor or camera. An additional region on the right and bottom side of the frame illustrates a partial region of the FOV output from the ultra-wide angle image sensor or camera, where such embodiment can be selectively implemented.

This optimization strategy as illustrated in FIG. 4B is designed to enhance power efficiency in multi-sensor or multi-camera devices. Instead of processing the entire output from the secondary (ultra-wide) image sensor, the processor can selectively utilize only the region necessary for effective EIS. This adaptive approach allows for dynamically adjusting the processed region based on real-time EIS requirements.

By implementing this selective processing technique, the imaging device 100 can achieve an extended effective FOV for stabilization while significantly reducing power consumption. This method eliminates the computational overhead associated with processing extraneous areas of the ultra-wide image that do not contribute to the stabilization process. The power-optimized multi-sensor or multi-camera fusion technique exemplifies a sophisticated approach to balancing high-quality image stabilization with energy efficiency. This methodology is particularly valuable in mobile or power-constrained imaging devices, where resource management is crucial for overall system performance and battery life.

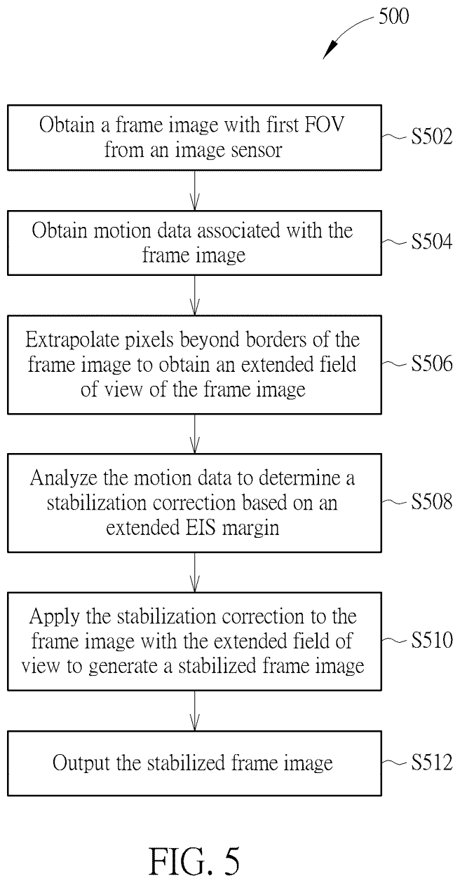

FIG. 5 depicts a flowchart of a method 500 for the electronic image stabilization according to the embodiments. The method 500 includes the following steps:

S502: Obtain a frame image with first FOV (for example, full FOV) from an image sensor;

S504: Obtain motion data associated with the frame image;

S506: Extrapolate pixels beyond borders of the frame image to obtain an extended field of view of the frame image;

S508: Analyze the motion data to determine a stabilization correction based on an extended electronic image stabilization (EIS) margin, wherein the extended EIS margin is derived from the extended field of view; and

S510: Apply the stabilization correction to the frame image with the extended field of view to generate a stabilized frame image;

S512: Output the stabilized frame image.

This flowchart encapsulates the core components and workflow of the innovative EIS technique, providing a structured representation of the operations. The flowchart systematically outlines the key steps involved in the stabilization process, from initial image capture to the final output of stabilized frames. Each step in the flowchart corresponds to a critical function discussed in the earlier paragraphs, offering a comprehensive overview of the EIS method. This visual representation serves to clarify the logical progression of the stabilization process and highlights the interconnections between various system components.

The various embodiments of the invention represent a significant advancement in electronic image stabilization (EIS) technology, offering several key advantages over prior art solutions. The technique can extend the effective field of view (FOV) beyond the physical limitations of the camera sensor is a groundbreaking feature, overcoming the traditional trade-off between stabilization quality and maintained FOV. By synthesizing new image content beyond the original frame, this technique allows for more aggressive stabilization without sacrificing edge content, resulting in smoother video output even in high-motion scenarios. The adaptive nature of this approach, which dynamically adjusts the extent and method of FOV extension based on real-time motion analysis, optimizes performance across various shooting conditions while efficiently managing computational resources.

Furthermore, the incorporation of advanced techniques such as AI-based image synthesis, multi-frame fusion, and multi-camera or multi-sensor or multi-camera spatial fusion demonstrates a holistic approach to EIS. These methods work in concert to provide a more comprehensive solution than traditional single-frame, single-camera stabilization techniques, resulting in more natural-looking and temporally consistent image output. The consideration of power efficiency, particularly in its approach to spatial fusion, addresses a critical concern in mobile imaging devices. By selectively processing only necessary regions from secondary cameras, the method achieves enhanced stabilization capabilities while minimizing power consumption. This balance of performance and efficiency positions the invention as a next-generation solution for video stabilization across a wide range of applications and devices, particularly valuable for implementation in smartphones and other power-constrained environments.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain voice or non-voice data/control information, regardless of whether these signals are analog or digital in nature.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for electronic image stabilization, comprising:
obtaining a frame image with first field of view (FOV) from an image sensor;
obtaining motion data associated with the frame image;
extrapolating pixels beyond borders of the frame image to obtain an extended field of view of the frame image;
analyzing the motion data to determine a stabilization correction based on an extended electronic image stabilization (EIS) margin, wherein the extended EIS margin is derived from the extended field of view; and
applying the stabilization correction to the frame image with the extended field of view to generate a stabilized frame image.

2. The method of claim 1, further comprising outputting the stabilized frame image.

3. The method of claim 1, wherein obtaining the motion data comprises obtaining the motion data from at least one motion sensor.

4. The method of claim 1, wherein obtaining the motion data comprises performing image alignment between the frame image and at least one previous frame image.

5. The method of claim 1, wherein extrapolating pixels around borders of the frame image comprises using a generative artificial intelligence (AI) model to synthesize new image content beyond borders of the frame image.

6. The method of claim 1, wherein extrapolating pixels around borders of the frame image comprises:
accessing one or more historical frame images from a queue of previously captured images; and
using content from the one or more historical frame images to extend the field of view of the frame image.

7. The method of claim 6, further comprising:
dynamically adjusting a number of historical frame images stored in the queue based on a magnitude of detected motion.

8. The method of claim 1, wherein extrapolating pixels around borders of the frame image comprises:
accessing image data from at least one secondary image sensor with a larger field of view; and
using the image data from the at least one secondary image sensors to generate the extended field of view of the frame image.

9. The method of claim 8, further comprising:
selectively capturing a partial region from the at least one secondary image sensors according a required extended field of view for stabilization.

10. The method of claim 1, further comprising calculating borders for the extended field of view according to at least one of:
a magnitude of detected motion;
a direction of detected motion; and
available computational resources.

11. An apparatus, comprising:
an image sensor, configured to obtain a frame image with first field of view (FOV); and
a processor coupled to the image sensor, configured to:
obtain motion data associated with the frame image;
extrapolate pixels around borders of the frame image to obtain an extended field of view of the frame image;
analyze the motion data to determine a stabilization correction based on an extended electronic image stabilization (EIS) margin; and
apply the stabilization correction to the frame image with the extended field of view to generate a stabilized frame image;
wherein the extended EIS margin is derived from the extended field of view.

12. The apparatus of claim 11, wherein the processor is further configured to output the stabilized frame image.

13. The apparatus of claim 11, the apparatus further comprising a motion sensor coupled to the processor, configured to obtain the motion obtained data.

14. The apparatus of claim 11, wherein the motion data is obtained by performing image alignment between the frame image and at least one previous frame image.

15. The apparatus of claim 11, wherein the processor is further configured to use a generative artificial intelligence (AI) model to synthesize new image content beyond borders of the frame image.

16. The apparatus of claim 11, wherein the processor is further configured to:
access one or more historical frame images from a queue of previously captured images; and
use content from the one or more historical frame images to extend the field of view of the frame image.

17. The apparatus of claim 16, wherein the processor is further configured to dynamically adjust a number of historical frame images stored in the queue based on a magnitude of detected motion.

18. The apparatus of claim 11, the apparatus further comprising a secondary image sensor with a larger field of view, configured to access additional image data, wherein the processor uses the additional image data to generate the extended field of view of the frame image.

19. The apparatus of claim 18, wherein the secondary image sensor is further configured to:
selectively capture a partial region according a required extended field of view for stabilization.

20. The apparatus of claim 11, wherein the processor is further configured to calculate borders for the extended field of view according to at least one of:
a magnitude of detected motion;
a direction of detected motion; and
available computational resources.
